(19) United States
(12) Patent Application Publication
(10) Pub. No.: US 2010/0226480 A1
(43) Pub. Date: Sep. 9, 2010

(54) METHOD AND APPARATUS FOR DETECTING LONG UNTERMINATED PHONE WIRING LOOPS

(75) Inventor: Nicolae Gedo, Manalapan, NJ (US)

Correspondence Address: MOSER IP LAW GROUP / VONAGE, 1030 BROAD STREET, SUITE 203, SHREWSBURY, NJ, 07702, US

(73) Assignee: VONAGE NETWORK LLC., Holmdel, NJ (US)

(21) Appl. No.: 12/717,381

(22) Filed: Mar. 4, 2010

Related U.S. Application Data
(60) Provisional application No. 61/209,243, filed on Mar. 4, 2009.

(51) Int. Cl. H04M 1/24; H04L 12/66

(52) U.S. Cl. 379/27.01; 370/352

(57) ABSTRACT

A method and apparatus for detecting unterminated phone line loops. The method comprises generating a voltage differential pulse across a phone line loop, measuring a voltage differential across the phone line loop, and determining if the phone line loop is properly terminated based upon the measured differential. The apparatus comprises a voltage pulse generator, two phone wires, and a voltage pulse detector. The voltage pulse generator sends a voltage differential pulse, the two phone wires carry the voltage differential, and the voltage pulse detector measures the voltage differential across the phone wires.

### CROSS-REFERENCE TO RELATED APPLICATIONS

This application claims benefit of U.S. provisional patent application Ser. No. 61/209,243, filed Mar. 4, 2009, which is herein incorporated by reference.

### BACKGROUND OF THE INVENTION

1. Field of the Invention

Embodiments of the present invention generally relate to Voice over Internet Protocol (VoIP) and, more particularly, to a method and apparatus for detecting unterminated phone wiring loops.

2. Description of the Related Art

Ubiquitous broadband internet access provides consumers with more options for communication than ever before. The high bandwidth provided by home networks provides an ideal platform for the transmission of telephony data. However, upgrading to these new communication platforms is often difficult due to the limitations of home wiring designed for legacy telephony systems.

Switching from a traditional Plain Old Telephone System (POTS) to a Voice over Internet Protocol (VoIP) system requires equipment that must be specially configured to interface with a particular home wiring setup. Tests such as the TELCORDIA GR909 test suite determine if the home wiring system is suitable for a VoIP system. These tests typically determine whether a phone line is still receiving voltage from a traditional POTS. However, these tests are unable to detect phone lines that are unpowered, but still coupled to an external phone system. This results in the VoIP system driving a longer phone line than expected, causing a degradation in communication quality. Therefore, there is a need in the art for a method and apparatus to detect long unterminated phone wiring loops.

### SUMMARY OF THE INVENTION

Embodiments of the present invention comprise a method and apparatus for detecting long unterminated phone line loops.

The method comprises generating a voltage differential pulse across a phone line loop, measuring a voltage differential across the phone line loop, and determining if the phone line loop is properly terminated based upon the measured differential.

The apparatus comprises a voltage pulse generator, two phone wires, and a voltage pulse detector. The voltage pulse generator sends a voltage differential pulse, the two phone wires carry the voltage differential, and the voltage pulse detector measures the voltage differential across the phone wires.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting a system in which an embodiment of the present invention is used;

FIG. 2 is a block diagram depicting a VoIP device implementing an embodiment of the present invention;

FIG. 3 is a schematic diagram of a loop detection circuit implementing an embodiment of the present invention;

FIG. 4 is a illustrative diagram of waveform results for a test implementing an embodiment of the present invention; and

FIG. 5 is a flow diagram depicting a method for testing for an unterminated telephone wire loop in accordance with an embodiment of the present invention.

### DETAILED DESCRIPTION

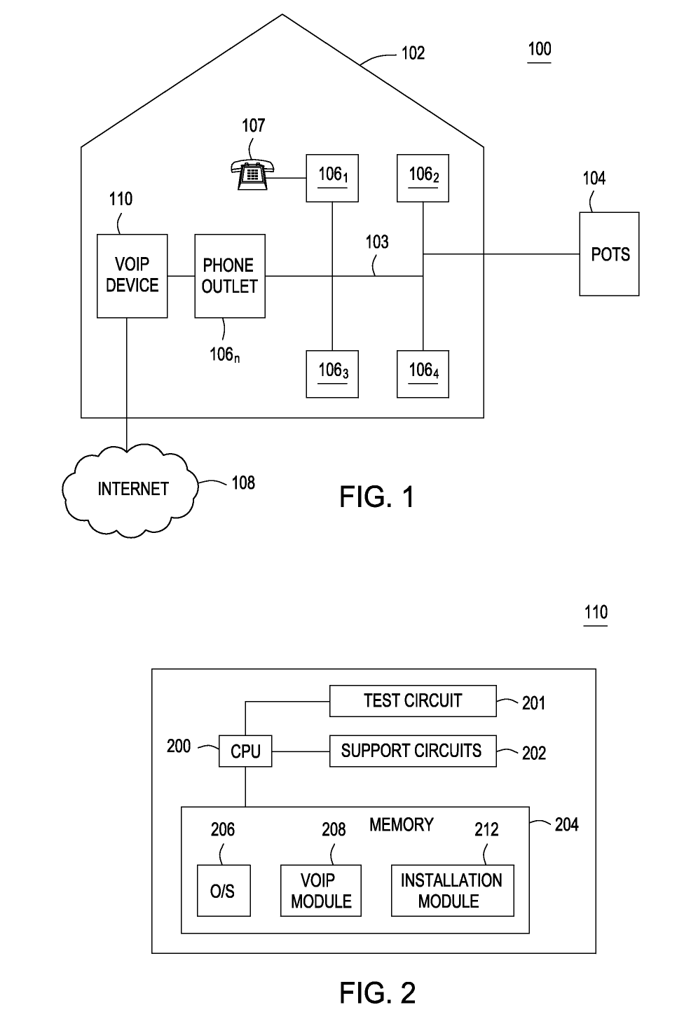

FIG. 1 depicts a home telephony system 100 containing an embodiment of the present invention. In a traditional home telephony system using a Plain Old Telephone System (POTS), telephone service is provided via an external POTS link 104. The POTS link 104 is coupled to a home wiring system 103. The home wiring system 103 is comprised of twisted pairs of copper wire for providing phone service to one or more phone outlets 106. One or more telephones 107 receive phone service by plugging in to the phone outlets 106.

Installing a VoIP system in a traditional home telephony system may prove difficult. A VoIP system requires a VoIP device 110 to replace the role of the POTS link 104. The term “VoIP system” refers to the combination of hardware and software elements required to receive VoIP telephony service, including the VoIP device 110, the home wiring 103, the phone outlets 106, and the telephones 107. The VoIP device 110 is coupled to a packet network 108 such as, but not limited to, the Internet. Telephone service is then provided over the home wiring system 103 by sending and receiving telephony data to a remote server (not shown) via the packet network 108.

In order to function properly, the VoIP device 110 must have full access to a telephone line on the home wiring system 103. If a POTS link 104 is still connected to the wiring pair to which the VoIP device 110 is connected, the VoIP device 110 will not function properly. Since most homes are set up for standard POTS service, installation of a VoIP system may prove problematic.

Before installing the VoIP system, connectivity tests are typically run to determine if the home wiring is suitably configured for VoIP communications. These connectivity tests, such as the TELCORDIA GR-909 test suite, are capable of determining whether a current is present on the home wiring, as would be provided by an active POTS link 104. However, if no current is present on the home wiring, but the wiring is still coupled to a POTS link 104, the user may experience suboptimal performance during VoIP communications caused by electrical noise present on the long, unterminated cable and wiring connection. Such performance may manifest as poor voice communication quality, dropped calls, and/or other issues.

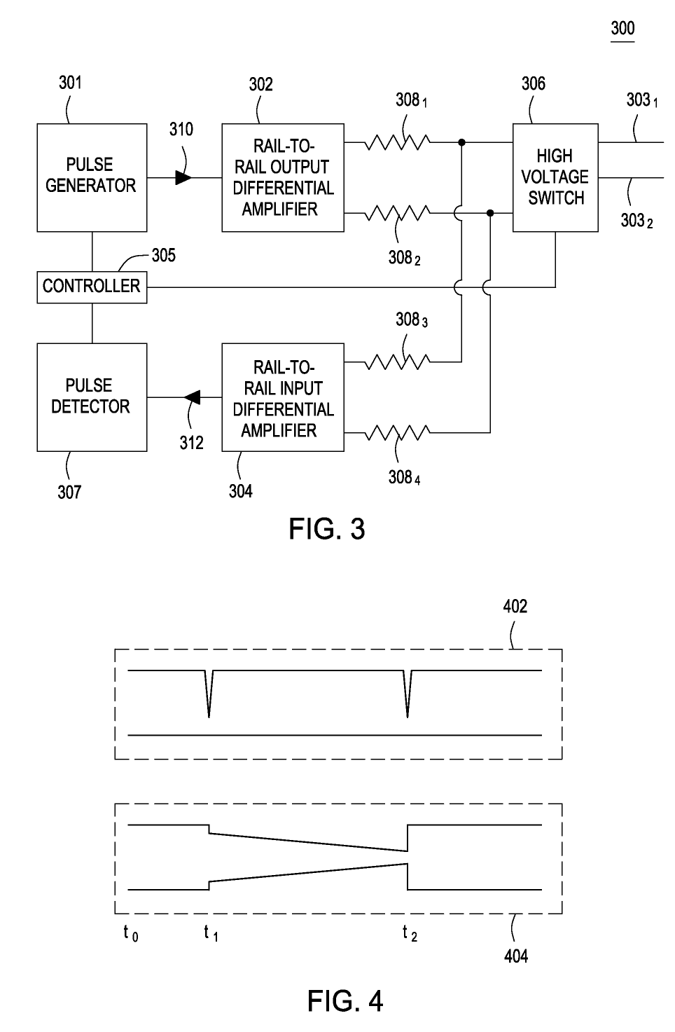

FIG. 2 depicts an embodiment of the VoIP device 110. In one embodiment, the VoIP device 110 is in the form of a general purpose computer such as those known in the art. The VoIP device 110 may include a central processing unit (CPU) 200, a test circuit 201 support circuits 202, and a memory 204. The CPU 200 may comprise one or more commercially available microprocessors or microcontrollers that facilitate data processing and storage. The various support circuits 202 are utilized to facilitate the operation of the CPU 200 and include such circuits as clock circuits, power supplies, cache, input/output (I/O) circuits and devices, modulation/demodulation devices, subscriber line interface circuits, and the like. The test circuit 201 is utilized to perform a test for an unterminated telephone wire loop in accordance with embodiments of the present invention. The test circuit 201 is discussed further with respect to FIG. 3.

The memory 204 may comprise random access memory, read only memory, removable storage, optical disk storage, disk drive storage, flash memory, and combinations thereof. The memory 204 stores an operating system 206, a VoIP module 208, an I/O driver 210, and a test module 212. The VoIP module 208 controls hardware responsible for providing home telephony services via the packet network 108. In operation, the CPU 200 executes the operating system 206 to control the general utilization and functionality of the host computer.

The memory 204 further comprises a test module 212. The test module 212 manages a series of one or more tests to determine if the home wiring is suitable for VoIP communications. The test module 212 controls the operation of the test circuit 201, generating tests and receiving test results. In some embodiments of the present invention, the test module 212 is an installation module as discussed in related U.S. patent application Ser. No. 12/642,521, herein incorporated by reference in its entirety. This installation module may manage installation and configuration process for connecting the VoIP device 110 to the home wiring 103. The installation module 212 installs, tests, and configures the VoIP device 110 through a process of sending status updates and user commands to an I/O module and receiving test and configuration data from the VoIP module 208.

FIG. 3 is a schematic diagram of an embodiment of a circuit for performing a test for an unterminated phone line in accordance with embodiment of the present invention. Such a circuit may be implemented as a test circuit 201 as present in an exemplary VoIP device 110. The circuit includes a pulse generator 301 coupled to a rail-to-rail output differential amplifier 302, a high voltage switch 306, a pulse detector 307, a rail-to-rail input differential amplifier 304, current limiting resistors 308₁, 308₂, 308₃, 308₄, and phone wires 303₁ and 303₂.

The pulse generator 301 is coupled to the rail-to-rail output differential amplifier 302, a controller 305, and the high voltage switch 306. The pulse generator 301 acts as a voltage source, applying a pulse 310 to the circuit for a brief period of time and closing the high voltage switch 306. The high voltage switch 306 protects the detection apparatus from the high voltages normally existing on the phone line. In a default state, the high voltage switch 306 is open.

The pulse 310 travels through the rail-to-rail output differential amplifier 302, where a differential is applied across the current limiting resistors 308₁, 308₂, and through the high voltage switch out to the phone wires 303₁ and 303₂. In some embodiments, the phone wires 303₁ and 303₂ correspond to the tip and ring pins of a common telephone line as known in the art, respectively. The current limiting resistors 308₁ . . . 308₄ determine the pulse amplitude as output and input by the differential amplifiers. The value of the current limiting resistors 308 value can be adjusted in order to accommodate different amplifiers and different loop lengths.

A rail-to-rail input amplifier 304 is coupled to the lines coupled to the phone wires 303. The rail-to-rail input amplifier 304 reads the differential between the two phone wires. The waveform of the differential is discussed further with respect to FIG. 4.

A capacitance exists between the phone wires 303₁ and 303₂. In a typical VoIP enabled phone system, the phone wires 303₁ and 303₂ are terminated within the home, with no outside connection to the POTS 104. Such a terminated connection will have a low capacitance. If the line out pins 303 are not terminated properly (e.g. they are still connected to the POTS 104), this results in a long, unterminated phone wiring loop with a large capacitance.

When the capacitance between the two phone wires 303 (as a result of the rail-to-rail output differential amplifier 302) is charged to the differential crossover level between the two phone wires, the rail-to-rail input differential amplifier 304 converts the registered differential into a pulse 312. In the typical VoIP enabled phone system with properly terminated phone lines, the low capacitance is charged by the pulse 310 and registered by the pulse detector 307. In an improperly terminated phone wiring loop, the capacitance is larger, such that the pulse is of insufficient power and/or duration to charge the capacitance of the phone line, resulting in no pulse registering at the input amplifier 304 and no pulse sent to the pulse detector 307. In some embodiments of the present invention, a pulse of 3 volts is applied for a period of 1 microsecond. Under proper conditions, such a pulse would not register if sent across six thousand feet of outdoor telephone line. One of ordinary skill in the art would recognize that the power and duration of the pulse could be altered for various configurations of line length, line inductance, and capacitance between the phone wires 303.

The controller 305 is coupled to the pulse generator 301 and the pulse detector 307. In some embodiments, the controller 305 receives instructions from the test module 212 to generate the voltage pulse. In some embodiments, the controller 305 alters the duration and power of the voltage pulse sent by the pulse generator 301. In some embodiments, the controller 305 receives a test result from the pulse detector 307. The controller 305 may then report the test result to the test module 212 to indicate if the test was successful.

FIG. 4 is an illustrative diagram of the input waveform received by the rail-to-rail input amplifier 304 in accordance with embodiments of the present invention. The first waveform 402 illustrates a properly terminated phone wiring loop. Such a phone wiring loop has a low capacitance, which is shown as a waveform 402 with droops at t₁ and t₂. The waveform is a delayed image of the pulse sent on the line by the output differential amplifier 302. The droops in the waveform occur when the capacitance between the phone wires 303 is charged and discharged, respectively.

The second waveform 404 illustrates an improperly terminated phone wiring loop. This phone wiring loop has a large capacitance. When the voltage differential is applied at t₁, the capacitance begins to charge. However, since the capacitance is so large, it is unable to fully charge before the voltage differential is removed at time t₂. As such, the differential registered by the rail-to-rail input differential amplifier is never sufficient to generate a pulse that will register on the pulse detector 307.

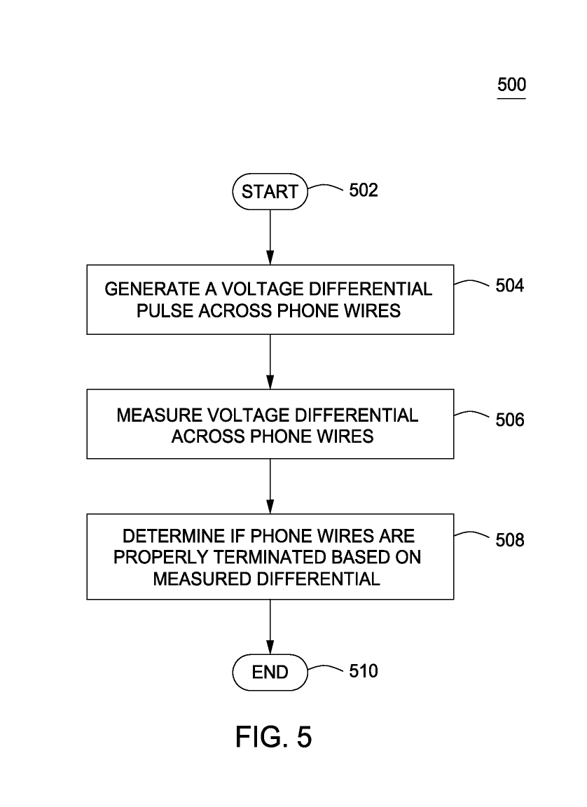

FIG. 5 is a flow diagram depicting a method for detecting unterminated phone line loops in accordance with embodiments of the present invention. The method begins at step 502, with a device (e.g. the VoIP device 110 as depicted in FIG. 1) coupled to a phone wiring system. At step 504, the device generates a voltage differential pulse across a phone line loop (e.g. the phone wires 303 as depicted in FIG. 3). The length and power of the pulse may vary as discussed with respect to FIG. 3.

At step 506, the differential across the phone line loop is measured. If the voltage pulse was sufficient to fully charge the capacitance between the phone lines, then the full differential will be measured by a pulse detector (e.g. the pulse detector 307 of FIG. 3).

At step 508, the method determines if the measured differential was sufficient to indicate a properly terminated phone line. If the voltage pulse was insufficient to charge the capacitance, then the pulse detector will not measure the full differential as generated by the pulse generator 301. A differential that exceeds a minimum threshold value is indicative of a properly terminated phone line loop, which will have a low capacitance. The threshold value is determined based upon the capacitance of a given length of phone line, where the given length is short enough that a VoIP system would be able to successfully operate. If the measured differential is small enough to indicate that the capacitance of the line is less than the threshold value (and thus the line is shorter than the maximum VoIP system length), then the method will indicate a successful test.

Not registering a pulse, or registering a pulse greater than the threshold value is indicative of an improperly terminated phone line loop. One of ordinary skill in the art would recognize that various powers and durations for the generated pulse would alter whether or not the pulse is registered by the detector for a given capacitance for a phone wiring loop. As such, one could alter the duration and/or power to detect wiring of a given length and/or inductance using the pulse detector. In some embodiments, this method may be performed by a computer such as the VoIP device 110 as discussed with respect to FIG. 2.

The method ends at step 510, when a result for the test has been determined.

While the foregoing is directed to embodiments of the present invention, other and further embodiments of the invention may be devised without departing from the basic scope thereof, and the scope thereof is determined by the claims that follow.

1. A method for detecting unterminated phone lines, the method comprising:
generating a voltage differential pulse across a phone line loop;
measuring a voltage differential across the phone line loop; and
determining if the phone line loop is properly terminated based upon the measured differential.

2. The method of claim 1, further comprising:
determining a power level and duration for the voltage differential pulse, wherein the power level and duration correspond to a particular capacitance for the phone line loop.

3. The method of claim 2, wherein the power level and duration are used to determine the length of the phone line loop.

4. The method of claim 1, controlled by a computer executing a test module for generating the voltage differential pulse and receiving the measurement of the differential.

5. The method of claim 4, performed as part of a Voice-over Internet Protocol (VoIP) system installation process.

6. The method of claim 1, further comprising identifying the phone line loop is suitable for VoIP communication if the measured voltage differential is greater than a threshold value.

7. The method of claim 6, wherein the threshold value is the voltage differential of the voltage differential pulse.

8. The method of claim 6, wherein the threshold value is determined by a controller based on a capacitance value of a particular length of wire.

9. The method of claim 8, wherein the particular length of wire is less than a maximum length that may be driven by a VoIP device.

10. An apparatus for detecting unterminated phone lines comprising:
a voltage pulse generator for sending a voltage differential pulse;
two phone wires for carrying the voltage differential; and
a voltage pulse detector for measuring the voltage differential across the phone wires.

11. The apparatus of claim 10, further comprising a rail-to-rail output differential amplifier for applying a source single voltage pulse across the phone wires to create a voltage differential across the phone wires.

12. The apparatus of claim 11, further comprising a rail-to-rail input differential amplifier for converting the voltage differential across the phone wires to a single pulse.

13. The apparatus of claim 10, further comprising a controller for controlling the voltage differential pulse and receiving a result from the pulse detector.

14. The apparatus of claim 13, wherein the controller alters at least one of the duration and power of the voltage differential pulse.

15. The apparatus of claim 10, further comprising a switch to protect the voltage pulse generator and pulse detector from high voltages produced across the phone wires.

16. The apparatus of claim 10, wherein the pulse detector is at least one of an external interrupt pin or a timer input pin on a VoIP device central processor.

17. The apparatus of claim 10, wherein the voltage pulse generator generates a pulse with a power of 3 volts for greater than 1 microsecond and less than 3 microseconds.

18. The apparatus of claim 10, wherein the phone wires are a tip wire and a ring wire.
